(19) United States
(12) Patent Application Publication
(10) Pub. No.: US 2023/0316237 A1
(43) Pub. Date: Oct. 5, 2023

(54) METHODS, INTERNET OF THINGS STSTEMS AND MEDIUM FOR OPTIMIZING SMART GAS WORK ORDER SCHEDULING

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Yuefei WU, Chengdu (CN); Bin LIU, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 18/332,646

(22) Filed: Jun. 9, 2023

(30) Foreign Application Priority Data
Apr. 11, 2023 (CN) 202310375854.7

(51) Int. Cl. G06Q 10/20; G06Q 50/06

(52) U.S. Cl. CPC G06Q 10/20; G06Q 50/06

(57) ABSTRACT

The embodiments of the present disclosure provide a method for optimizing smart gas work order scheduling implemented by an Internet of Things system for optimizing smart gas work order scheduling, the Internet of Things system includes a smart gas user platform, a smart gas service platform, and a smart gas management platform that interact in sequence, wherein the method is executed by the smart gas management platform, and a smart gas service sub-platform may generate a work order to be assigned based on a gas processing request. The gas processing request refers to a request that is sent by the user to process a gas-related problem. The gas-related problems may include fault reporting, service complaint, gas device function inquiry, gas new product inquiry, etc.

### CROSS-REFERENCE TO RELATED APPLICATIONS

This application claims priority to Chinese Patent Application No. 202310375854.7, filed on Apr. 11, 2023, the entire contents of each of which are incorporated herein by reference.

### TECHNICAL FIELD

The present disclosure relates to the field of gas Internet of Things system, and in particular to methods and Internet of Things systems for optimizing smart gas work order scheduling, and medium.

### BACKGROUND

In gas service, every time a service system receives a gas processing request from a user, a gas work order is generated and staff is dispatched to process the request. However, there are many uncertainties in dispatching the staff, such as varying processing levels of staff, no currently available staff, etc., which may easily lead to problems such as untimely processing of gas problems and long processing time for the gas problems.

Therefore, it is desirable to provide methods and Internet of Things systems for optimizing smart gas work order scheduling, and mediums that may achieve accurate, timely and efficient dispatching of work orders.

### SUMMARY

According to one or more embodiments of the present disclosure, a method for optimizing smart gas work order scheduling is provided, the method is implemented by an Internet of Things system for optimizing smart gas work order scheduling, including a smart gas user platform, a smart gas service platform, and a smart gas management platform that interact in sequence, the method is performed by the smart gas management platform, including: obtaining newly-generated work orders to be assigned from the smart gas service platform, wherein a newly-generated work order to be assigned is generated by the smart gas service platform based on a gas processing request received from the smart gas user platform; determining at least one target scheduling sub-domain corresponding to the work order to be assigned from a plurality of scheduling sub-domains based on a gas inquiry feature of the work order to be assigned and a gas user feature of the work order to be assigned through a preset approach, wherein the gas inquiry feature includes at least one of an inquiry type and inquiry location information, and the gas user feature includes at least one of a user type, a terminal type, and a usage feature; and assigning the work order to be assigned to a corresponding target scheduling sub-domain.

According to one or more embodiments of the present disclosure, the Internet of Things system for optimizing smart gas work order scheduling is provided, including the smart gas user platform, the smart gas service platform, and the smart gas management platform that interact in sequence, the smart gas management platform being configured to: obtain the newly-generated work order to be assigned from the smart gas service platform, wherein the newly-generated work order to be assigned is generated by the smart gas service platform based on the gas processing request received from the smart gas user platform; determine the at least one target scheduling sub-domain corresponding to the work order to be assigned from the plurality of scheduling sub-domains based on the gas inquiry feature and the gas user feature of the work order to be assigned through the preset approach, wherein the gas inquiry feature includes at least one of the inquiry type and the inquiry location information, and the gas user feature includes at least one of the user type, the terminal type, and the usage feature; and

According to one of the embodiments of the present disclosure, a non-transitory computer-readable storage medium that stores computer instructions is provided, when reading the computer instructions in the storage medium, a computer executes the method for optimizing smart gas work order scheduling of any one of the above embodiments.

### BRIEF DESCRIPTION OF THE DRAWINGS

The present disclosure will be further described in the form of exemplary embodiments, which will be described in detail by the accompanying drawings. These embodiments are not limiting, in these embodiments, the same number denotes the same structure, wherein:

FIG. 1 is a schematic diagram illustrating an Internet of Things system for optimizing smart gas work order scheduling according to some embodiments of the present disclosure;

FIG. 2 is an exemplary flowchart illustrating a method for optimizing smart gas work order scheduling according to some embodiments of the present disclosure;

FIG. 3 is an exemplary flowchart illustrating a process of determining a plurality of scheduling sub-domains by clustering, according to some embodiments of the present disclosure;

FIG. 4 is an exemplary schematic diagram of determining a target scheduling sub-domain through a vector according to some embodiments of the present disclosure;

FIG. 5 is an exemplary flowchart illustrating a process of performing an order acceptance scheduling work orders to be assigned acceptance scheduling of work orders to be assigned according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the accompanying drawing in the following description is merely some examples or embodiments of the present disclosure, for those skilled in the art, the present disclosure may further be applied in other similar situations according to the drawings without any creative effort. Unless obviously obtained from the context or the context illustrates otherwise, the same numeral in the drawings refers to the same structure or operation.

It will be understood that the term “system,” “device,” “unit,” and/or “module” used herein are one method to distinguish different components, elements, parts, sections, or assemblies of different levels in ascending order. However, if other words may achieve the same purpose, the words may be replaced by other expressions.

As used in the disclosure and the appended claims, the singular forms “a,” “an,” and “the” include plural referents unless the descriptions clearly dictate otherwise. Generally speaking, the terms “comprise” and “include” only imply that the clearly identified steps and elements are included, and these steps and elements may not constitute an exclusive list, and the method or device may further include other steps or elements.

Flowcharts are used throughout the present disclosure to illustrate the operations performed by the system according to embodiments of the present disclosure. It should be understood that the preceding or following operations are not necessarily performed in precise order. Instead, the individual steps may be processed in reverse order or simultaneously. It is also possible to add other operations to these processes or to remove a step or steps of operations from these processes.

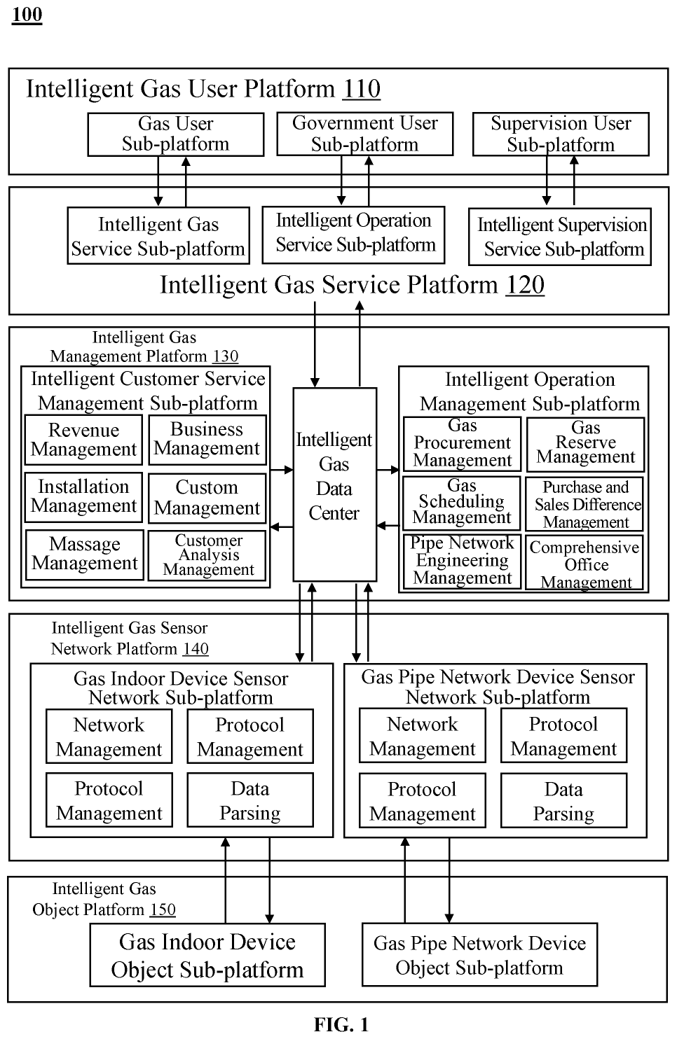

FIG. 1 is a schematic diagram illustrating an Internet of Things system for optimizing smart gas work order scheduling according to some embodiments of the present disclosure.

As shown in FIG. 1, an Internet of Things system 100 for optimizing smart gas work order scheduling includes a smart gas user platform 110, a smart gas service platform 120, a smart gas management platform 130, a smart gas sensor network platform 140, and a smart gas object platform 150. In some embodiments, the Internet of Things system 100 for optimizing smart gas work order scheduling may be a part of or implemented by a processing device.

The smart gas user platform 110 may refer to a user-driven platform. In some embodiments, the smart gas user platform 110 may be configured as a terminal device.

In some embodiments, the smart gas user platform 110 may include a gas user sub-platform, a government user sub-platform, and a supervision user sub-platform. The gas user sub-platform may be used for a user who use gas. The gas user sub-platform may obtain input instructions from a gas user. The government user sub-platform may be used for a government user. The government user sub-platform may obtain the input instructions from the government user. The supervised user sub-platform may be used for supervised users. For example, the supervision user may include related persons and/or departments concerned with ensuring gas safety. The supervision user sub-platform may obtain the input instructions from the supervision user.

The smart gas service platform 120 refers to a platform that may provide an input service and an output gas service to the user.

In some embodiments, the smart gas service platform 120 may include a smart gas service sub-platform, a smart operation service sub-platform, and a smart supervision service sub-platform.

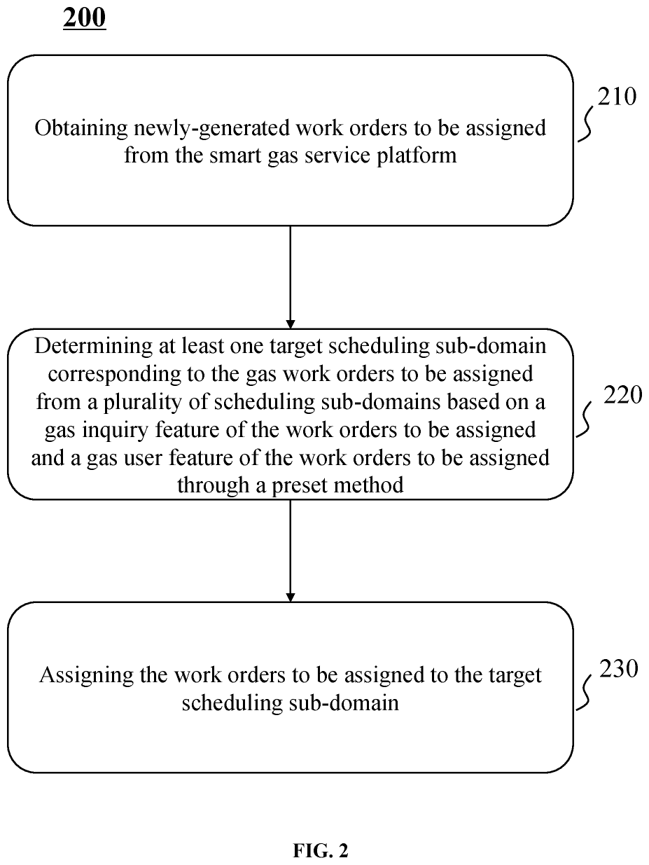

The smart gas service sub-platform may correspond to the gas user sub-platform. In some embodiments, the smart gas service sub-platform may generate a work order to be assigned based on a gas processing request received from the gas user sub-platform. The gas processing request is a request that is sent by the user to process a gas-related problem. The gas-related problem may include fault reporting, service complaint, gas device function inquiry, gas new product inquiry, etc. More description regarding the work orders to be assigned and how to generate the work orders to be assigned may be found in FIG. 2 and its related descriptions.

The smart operation service sub-platform may interact with the government user sub-platform. For example, the smart operation service sub-platform may receive the input instructions (e.g., gas operation management information inquiry instructions) from the government user sub-platform, and send the gas operation management information (e.g., scheduling plans for gas work orders) to the government user sub-platform.

The smart supervision service sub-platform may interact with the supervision user sub-platform. For example, the smart supervision service sub-platform may transmit safety supervision information such as pipe network device condition, gas pressure, etc. to the supervision user sub-platform based on the input instructions.

The smart gas management platform 130 may provide a platform for functions of perception management and control management of the Internet of Things system 100 for optimizing smart gas work order scheduling. In some embodiments, the smart gas management platform 130 may be a remote platform controlled by a manager, artificial intelligence, or preset rules.

In some embodiments, the smart gas management platform 130 may include a smart gas data center, a smart clientele service management sub-platform, and a smart operation management sub-platform.

The smart gas data center may aggregate and store all operational data of the Internet of Things system 100 for optimizing smart gas work order scheduling. The smart gas management platform 130 may interact with the smart gas service platform 120 and the smart gas sensor network platform 140 through the smart gas data center.

Both the smart clientele service management sub-platform and the smart operation management sub-platform may be independent data usage platforms. The smart clientele service management sub-platform and the smart operation management sub-platform may obtain related data from the smart gas data center and send management operation data to the smart gas data center. In some embodiments, the smart clientele service management sub-platform may include a revenue management module, a business account management module, an installation management module, a clientele service management module, a message management module, and a user analysis management module. In some embodiments, the smart operation management sub-platform may include a gas procurement management module, a gas reserve management module, a gas consumption scheduling management module, a purchase and sales difference management module, a pipeline network engineering management module, and a comprehensive office management module, etc.

Exemplarily, the smart gas data center may receive instructions of querying the gas operation management information from the smart operation service sub-platform and receive the work orders to be assigned from the smart gas service sub-platform. The smart gas data center may send the instructions of obtaining gas indoor related information and/or pipeline network device related information to the smart gas sensor network platform. The smart gas data center may receive gas network related information uploaded by the smart gas sensor network platform and send the related information to the smart operation clientele service sub-platform for processing to obtain, for example, a gas inquiry feature, a gas user feature, and other information. The smart operation management sub-platform may determine a target scheduling sub-domain and assign the work order based on information such as, the gas inquiry feature and the gas user feature, thereby determining the gas operation management information and a scheme of solving the gas-related problem. More descriptions of determining the target scheduling sub-domain and assigning the work order may be found in FIG. 2 and its related descriptions. The smart operation management sub-platform and sends the gas operation management information and solutions to gas-related problems to the smart gas data center. The smart gas data center may send the gas operation management information and the scheme of solving the gas-related problem to the smart gas service platform.

In some embodiments, the smart gas management platform may obtain a newly-generated work orders to be assigned from the smart gas service platform; determine at least one target scheduling sub-domain corresponding to the work orders to be assigned from a plurality of scheduling sub-domains by a preset approach based on the gas inquiry feature of the work orders to be assigned and the gas user feature of the work orders to be assigned; and assign the work orders to be assigned to a target scheduling sub-domain corresponding to the work orders to be assigned. More descriptions regarding of assigning the work orders to be assigned to the target scheduling sub-domain may be found in FIG. 2 and its related descriptions.

The smart gas sensor network platform 140 may refer to a functional platform for managing sensing communication of the Internet of Things system 100 for optimizing smart gas work order scheduling. In some embodiments, the smart gas sensor network platform 140 may be configured as a communication network and gateway. The smart gas sensor network platform 140 may send the instructions of obtaining related data (e.g., gas household and/or pipeline network device data) to the smart gas object platform 150 and receive the related data uploaded by the smart gas object platform 150. The smart gas sensor network platform 140 may receive the instructions of obtaining the related data sent by the smart gas data center, and upload the related data to the smart gas data center.

In some embodiments, the smart gas sensor network platform 140 may include a gas indoor device sensor network sub-platform and a gas pipeline network device sensor network sub-platform. Both the gas indoor device sensor network sub-platform and the gas pipeline network device sensor network sub-platform may perform one or more functions such as network management, protocol management, instruction management, and data parsing.

The smart gas object platform 150 may refer to a functional platform for generating perception information. The smart gas object platform 150 may be configured with various types of gas devices. A gas device may include an indoor device and a pipeline network device. The indoor device may include the gas terminal of gas user (e.g., a gas meter, etc.). The pipeline network device may include a gas regulating station, a pipeline network monitoring device, a pipeline network valve control device, etc.

In some embodiments, the smart gas object platform 150 may include a gas indoor device object sub-platform and a gas pipeline network device object sub-platform. In some embodiments, the gas indoor device object sub-platform may correspond to the gas indoor device sensor network sub-platform, and the gas pipeline network device object sub-platform may correspond to the gas pipeline network device sensor network sub-platform.

In some embodiments, the gas indoor device sensor network sub-platform may transmit corresponding gas terminal information obtained by the gas indoor device object sub-platform to the smart gas data center. The gas pipeline network device sensor network sub-platform may transmit the corresponding gas terminal information obtained through the gas pipeline network device object sub-platform to the smart gas data center.

It should be noted that the above descriptions of the Internet of Things system for optimizing smart gas work order scheduling are merely provided for the purposes of illustration, and not intended to limit the scope of the present disclosure. For those skilled in the art, after understanding the principle of the system, it may be understood to probably make any combination of various individual modules or form sub-systems to connect with other modules without departing from the principle.

FIG. 2 is an exemplary flowchart illustrating a method for optimizing smart gas work order scheduling according to some embodiments of the present disclosure. As shown in FIG. 2, process 200 includes operations described below. In some embodiments, process 200 may be performed by a smart gas management platform.

Step 210, obtaining a newly-generated work orders to be assigned from the smart gas service platform.

A work order refers to a task or operation related to gas service. For example, the work order may at least include one of gas maintenance, gas inspection, gas meter reporting, etc.

A work order to be assigned is a work order that need to be assigned and await processing. In some embodiments, the work orders to be assigned may be generated by the smart gas service platform based on a gas processing request received from the smart gas user platform. More descriptions regarding the gas processing request may be found in FIG. 1 and its related descriptions.

In some embodiments, the smart gas management platform may obtain the work orders to be assigned and generated timely from the smart gas service platform. Exemplarily, the smart gas management platform may issue the instructions of obtaining the work orders to be assigned to the smart gas service platform. The smart gas management platform may receive the work orders to be assigned and uploaded by the smart gas service platform.

Step 220, determining at least one target scheduling sub-domain corresponding to the work orders to be assigned from a plurality of scheduling sub-domains based on a gas inquiry feature of the work orders to be assigned and a gas user feature of the work orders to be assigned through a preset approach.

A gas inquiry feature may reflect an inquiry state of the work order. In some embodiments, the gas inquiry feature includes at least one of an inquiry type, and inquiry location information. In some embodiments, the gas inquiry feature of the work order may be obtained by analyzing and processing the work orders to be assigned through various manners, such as voice recognition, text parsing, and positioning.

The inquiry type may refer to a type of inquiry content. For example, the inquiry type may at least include one of the fault reporting, the service complaint, the gas device function inquiry, the gas new product inquiry, etc.

The inquiry location information may refer to geographic location information of the user who sent the inquiry. In some embodiments, the inquiry location information may be determined by locating the user who send the inquiry through a call system of the smart gas user platform.

The gas user features may reflect related situations of the user corresponding to the work order. In some embodiments, the gas user feature includes at least one of a user type, a terminal type, and a usage feature. In some embodiments, the smart gas management platform may determine the gas user feature corresponding to the work order according to the user corresponding to the work orders to be assigned, based on the gas pipeline network related information obtained from the smart gas object platform through the smart gas sensor network platform.

The user type may refer to a type that reflects a type reflecting inquiry gas service, for example, a residential type, a commercial type, an industrial type, etc.

A terminal type may refer to a type of gas device used by the user, for example, a gas stove, a smelting boiler, a gas meter, a flow meter, etc.

A usage feature may refer to a feature reflecting a situation of the user using gas, for example, a frequency of gas usage, an average time of each gas usage, etc.

A scheduling sub-domain may refer to a pre-defined sub-region for processing work orders. Each scheduling sub-domain may at least include one personnel that accept the work order. The personnel that accept the work order may refer to a staff member who processes the work orders to be assigned. Each scheduling sub-domain may process one or more work orders of a same type (e.g., with a same terminal feature) to be assigned. In some embodiments, the work orders to be assigned within the each scheduling sub-domain may only be picked up by the personnel that accept the work orders within that scheduling sub-domain, and the personnel that accept the work orders within each scheduling sub-domain may only pick up the work orders to be assigned within that scheduling sub-domain.

Exemplarily, the smart gas management platform may receive classification criteria (e.g., based on user features) input by the user and classify work orders to be assigned based on the classification criteria. The smart gas management platform may determine a corresponding count of scheduling sub-domains based on a count of types of the work orders to be assigned after classification. Each type of the work orders to be assigned may be respectively used as a scheduling sub-domain capable of processing the type of the work orders to be assigned. Historical personnel that accept the work order corresponding to each type of the work orders to be assigned may be determined as the personnel that accept the work orders of the scheduling sub-domain corresponding to that type.

In some embodiments, the plurality of scheduling sub-domains may be determined based on historical work orders to be assigned within a preset time period. The preset time period may be a preset historical time period.

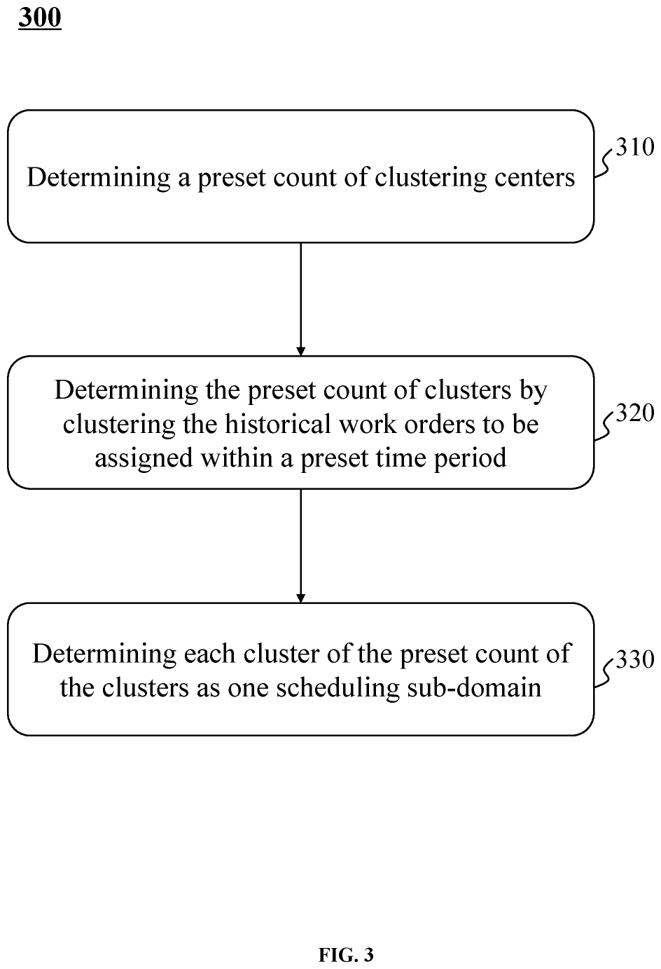

In some embodiments, the smart gas management platform may determine a preset count of clustering centers. The smart gas management platform may determine the preset count of clusters by clustering the historical work orders to be assigned within the preset time period. The smart gas management platform may determine each cluster as the scheduling sub-domain. More descriptions of determining the scheduling sub-domain through clustering may be found in FIG. 3 and its related descriptions.

The target scheduling sub-domain is a scheduling sub-domain that may be used to process the work orders to be assigned.

A preset approach is a method used to determine the target scheduling sub-domain. In some embodiments, the preset approach may be to preset a mapping table. For example, the smart gas management platform may determine a historical gas inquiry features and historical gas user features of the plurality of work orders at historical time as first reference data, and generate a first mapping relationship table of the first reference data and a corresponding historical scheduling sub-domain. The smart gas management platform may query the first reference data in the first mapping relationship table with a same or similar gas inquiry feature and gas user feature of a current work order, and determine its corresponding historical scheduling sub-domain as the target scheduling sub-domain of a current work orders to be assigned.

In some embodiments, the smart gas management platform may determine at least one target scheduling sub-domain corresponding to the work orders to be assigned based on the gas inquiry feature of the work orders to be assigned and the gas user feature of the work orders to be assigned and the gas work order feature of the work orders to be assigned. More descriptions regarding the gas work order feature may be found in FIG. 3 and its related descriptions.

Exemplarily, the above first reference data may include the gas work order feature of the work order in addition to the historical gas inquiry features and the historical gas user features. The smart gas management platform may query the first reference data in the first mapping relationship table that has the same or similar features as the gas inquiry feature of the current work order, the gas user feature of the current work order, and the gas work order feature of the current work order, and determine its corresponding historical scheduling sub-domain as the target scheduling sub-domain of the current work orders to be assigned.

The method of some embodiments of the present disclosure may fully combine various features such as the gas inquiry feature, the gas user feature, and the gas work order feature to determine an appropriate target scheduling sub-domain for the current work orders to be assigned, thereby improving an efficiency of subsequent assignment and processing of the work orders.

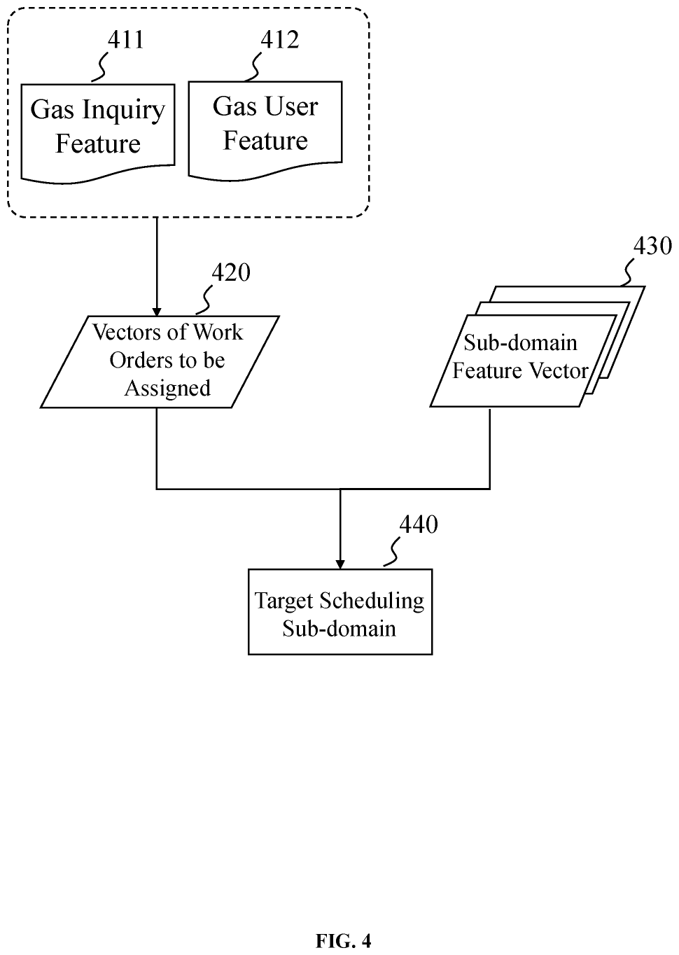

In some embodiments, the smart gas management platform may determine the vector of the work orders to be assigned based on the gas inquiry feature of the work orders to be assigned and the gas user feature of the work orders to be assigned; and determine the target scheduling sub-domain corresponding to the work orders to be assigned based on the vector of the work orders to be assigned and sub-domain feature vectors of the plurality of scheduling sub-domains. More description regarding how to determine the target scheduling sub-domain through the vector of the work orders to be assigned and the sub-domain feature vectors may be found in FIG. 4 and its related descriptions.

In some embodiments, the preset approaches may also include modeling, regression analysis methods, etc., without limitation herein.

Step 230, assigning the work orders to be assigned to the target scheduling sub-domain.

In some embodiments, the smart gas management platform may assign the work orders to be assigned to the target scheduling sub-domain. The work orders to be assigned in the target scheduling sub-domain may be updated. The personnel that accept the work order in this scheduling sub-domain may process the work orders to be assigned.

In some instances, the smart gas management platform may perform the order acceptance scheduling on the work orders to be assigned in each scheduling sub-domain. The order acceptance scheduling refers to assign the work orders to be assigned in the target scheduling sub-domain to the personnel that accept the work order in the target scheduling sub-domain.

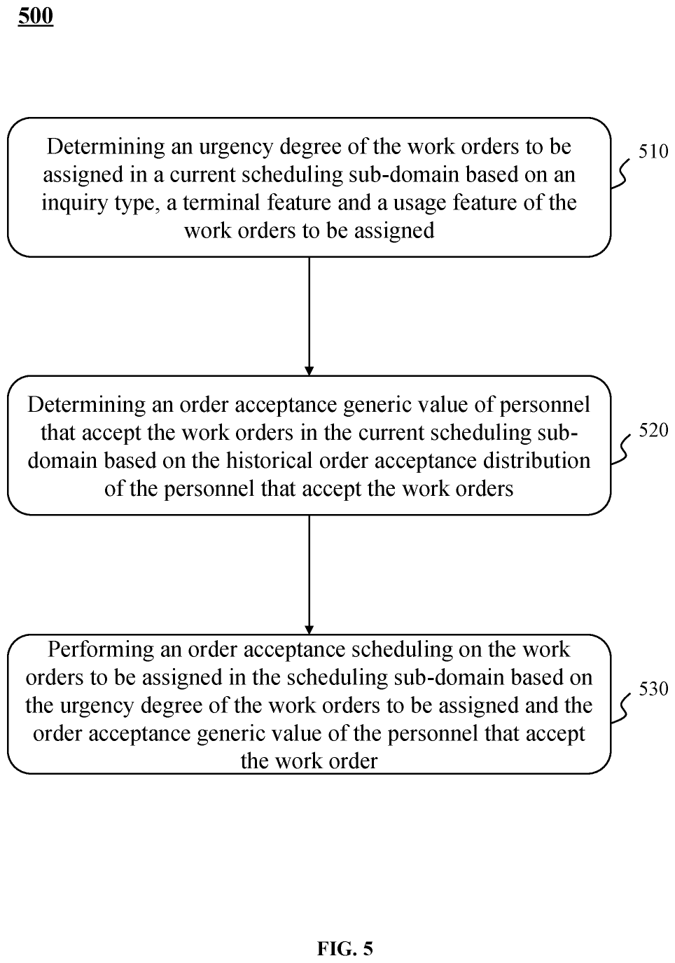

In some embodiments, the smart gas management platform may determine the urgency degree of the work orders to be assigned in the current scheduling sub-domain based on the inquiry type, the terminal feature, and the usage feature of the work orders to be assigned. The smart gas management platform may determine the order acceptance generic value of the personnel that accept the work order in the current scheduling sub-domain based on a historical order acceptance distribution of the personnel that accept the work order. The smart gas management platform may perform the order acceptance scheduling on the work orders to be assigned in the scheduling sub-domain based on the urgency degree of the work orders to be assigned and the order acceptance generic value of the personnel that accept the work order. More descriptions of performing the order acceptance scheduling based on the urgency degree and the order acceptance generic value may be found in FIG. 5 and its related descriptions.

In some embodiments, the smart gas management platform may also perform the order acceptance scheduling in other ways, for example, by sequentially assigning the work order to available personnel that accept the work order based on generation time of the work orders to be assigned, etc., which is not limited herein.

The method of some embodiments of the present disclosure may achieve a scientific order acceptance scheduling by assigning the work orders to be assigned to the appropriate personnel that accept the work order in various ways, so that an efficiency of accepting the order and an efficiency of processing the order may be improved.

The method of some embodiments of the present disclosure improves the efficiency of accepting the work order and the efficiency of processing the work order by comprehensively analyzing a plurality of features of the work orders and constructing a plurality of scheduling sub-domains, thereby ensuring efficient and orderly operation of the gas platform when the gas platform has a large count of different work orders.

FIG. 3 is an exemplary flowchart illustrating a process of determining a plurality of scheduling sub-domains by clustering, according to some embodiments of the present disclosure. In some embodiments, process 300 may be performed by a smart gas management platform.

Step 310, determining a preset count of clustering centers.

The smart gas management platform may set a preset count based on empirical values, system defaults, etc. or any combination thereof. In some embodiments, the preset count does not exceed the total count of personnel that accept the work orders.

Step 320, determining the preset count of clusters by clustering the historical work orders to be assigned within a preset time period.

A cluster may refer to a set of work orders consisting of one or more historical work orders to be assigned. The smart gas management platform may determine the preset count of clusters based on clustering features by clustering the historical work orders to be assigned of the preset time period using a clustering algorithm. More descriptions regarding the preset time period may be found in FIG. 2 and its related descriptions. In some embodiments, there may be a plurality of historical work orders to be assigned. The smart gas management platform may construct a set of historical feature vectors based on the set of the historical work orders to be assigned. The historical feature vector may be a vector representation of the historical work orders to be assigned. Elements of the history feature vector may correspond to the features included in the clustering feature (e.g., the gas inquiry feature, the gas user feature, etc.). The smart gas management platform may cluster the set of historical feature vectors by a clustering algorithm to obtain the set of the preset count of clusters. Each cluster the preset count of clusters may have a corresponding clustering center. The clustering algorithm may include, but are not limited to, a K-Means clustering algorithm, a DBSCAN algorithm, etc.

The clustering feature may refer to features of the historical work orders to be assigned for clustering. In some embodiments, the clustering features may at least include gas inquiry features of the historical work orders to be assigned and gas user features of the historical work orders to be assigned. More descriptions of how to obtain the gas inquiry feature and gas user feature of work orders may be found in FIG. 2 and its related descriptions.

In some embodiments, the clustering feature may include gas work order features of the historical work orders to be assigned in addition to the gas inquiry features and the gas user features. The gas work order feature may reflect a situation of service communication of the work order. In some embodiments, the gas work order feature includes at least one of a call inquiry duration and a message interaction degree.

The call inquiry duration may refer to a duration of a service call corresponding to the work order. The service call may be initiated by the user.

Am information interaction degree may be used to measure a degree of the information interaction between the user and a clientele service for communication. In some embodiments, the information interaction degree may be determined based on a speech recognition technology. In some embodiments, the smart gas user platform may respectively recognize a duration of each speech of the clientele service and a duration of each speech of the user, determine a communication frequency between the clientele service and the user, and determine the information interaction degree based on the communication frequency. For example, the greater the communication frequency, the greater the information interaction degree. Communication frequency=count of times of communication/duration of call inquiry. After a user completes a speech, the clientele service makes a reply, which may be counted as one communication.

The methods of some embodiments of the present disclosure may cluster the work orders to be assigned by combining the gas work order features of the historical work orders to be assigned, so that the situation of the service communication of the scheduling sub-domains obtained after clustering is similar, and such that target scheduling sub-domains that match fault situations of the work orders to be assigned are convenient to be determined subsequently.

In some embodiments, in addition to the gas inquiry feature and the gas user feature, the clustering feature include historical gas fault distribution and fault inquiry data of the historical work orders to be assigned.

The historical gas fault distribution may reflect the fault situation of the gas terminal of the user corresponding to the work order at a historical time. The historical gas fault distribution may include historical fault types and occurrence frequency corresponding to the historical fault. The fault type may be insufficient gas pressure, insufficient battery power of the gas terminal, etc. The fault frequency may reflect a count of times of a fault occurred over a period of time (e.g., the above preset time period).

In some embodiments, the historical gas fault distribution may be represented as a vector (p_{A}, p_{B}, p_{C} . . . , p_{N}), where p_{A} may indicate the occurrence frequency of faults of fault type A, p_{B} may indicate the occurrence frequency of faults of fault type B, and so on.

The fault inquiry data is the related data of situation the clientele service inquiry about the fault. The fault inquiry data may include questions asked by the clientele service and answers given by the user. Understandably, the clientele service may understand a basic situation of the fault by asking the user questions related to the fault, e.g., questions related to the fault may be “Does the gas ignite properly?” etc.

In some embodiments, in addition to the gas inquiry feature, the gas user feature, the historical gas fault distribution of the historical work orders to be assigned, and the fault inquiry data, the clustering feature may also include difficulty in predicting the fault of the historical work orders to be assigned. The difficulty of predicting the fault may be used to measure a degree of difficulty in determining the type of gas fault.

In some embodiments, the difficulty of predicting the fault may be determined based on the historical gas fault distribution and/or the gas work order feature.

In some embodiments, the smart gas management platform may determine the difficulty of predicting the fault according to the occurrence frequency of the fault of the historical gas fault distribution.

In some embodiments, if the occurrence frequency of each type of fault in the historical gas fault distribution is closer, which means that it is more difficult to determine the most probable type of fault to occur this time, at which point the fault is more difficult to predict. For example, when a difference between a minimum value and a maximum value of the frequency of the fault in the historical gas fault distribution of the work orders to be assigned is less than a set threshold, which means that the occurrence frequency of each type of fault is closer.

In some embodiments, the smart gas management platform may calculate the difference between the maximum value of the occurrence frequency of the gas faults in the historical distribution and other values of the occurrence frequency of the gas faults in the historical distribution, and determine a sum of all the differences, and determine the sum of all the differences as the difficulty of predicting the faults. As another example, the smart gas management platform may calculate a variance of the occurrence frequency of the faults in the historical gas fault distribution before removing the maximum value, calculate a variance of the occurrence frequency of the faults in the historical gas fault distribution after removing the maximum value, and determine the difference of the two variances as the difficulty of predicting the faults.

In some embodiments, the greater the call inquiry duration and the information interaction degree, the less difficult of predicting the fault. It should be understood that the greater the call duration and the information interaction degree, the more detailed the related information of the fault available to the clientele service, and the easier of predicting the type of fault.

In some embodiments, the difficulty of predicting the fault may also be determined by the following equation (1):

$$D = \frac{k}{( t \cdot i \cdot s )} \qquad ( 1 )$$

where t is the call inquiry duration. i is the information interaction degree. s is the sum of the differences between the maximum values of the distribution frequency in the historical gas fault distribution and other values of the distribution frequency in the historical gas fault distribution. k is a preset coefficient, and k may be set based on empirical values, system defaults, etc., or any combination thereof.

The methods of some embodiments of the present disclosure may combine the difficulty of predicting the fault to cluster the work orders to be assigned so that the difficulty of predicting the fault of the scheduling sub-domains obtained after clustering is similar, and thus the target scheduling sub-domain that match the difficulty of predicting the fault of the work orders to be assigned is convenient to be determined subsequently.

The methods of some embodiments of the present disclosure cluster may combine the situation of historical fault to cluster the work orders to be assigned through, for example, the historical gas fault distribution and the situation of the fault inquiry data, so that the scheduling sub-domains obtained after clustering have similar historical fault conditions, and thus the target scheduling sub-domains that match the fault conditions of the work orders to be assigned is convenient to be determined subsequently.

Step 330, determining each cluster of the preset count of the clusters as one scheduling sub-domain.

The smart gas management platform may determine each cluster of a preset count of clusters as one scheduling sub-domain. In some embodiments, the work orders to be assigned that have a vector distance (e.g., a Euclidean distance, a cosine distance, etc.) smaller than a threshold to the cluster center of a cluster corresponding to a scheduling sub-domain may be determined as the work orders to be assigned that may be processed by the scheduling sub-domain.

In some embodiments, the smart gas management platform determines the personnel that accept the work orders of each scheduling sub-domain based on the data of historical order acceptance of the personnel that accept the work order. For example, the smart gas management platform may determine a corresponding set of historical order acceptance vectors based on the historical order acceptance data of all personnel that accept the order (e.g., the gas inquiry features of the historical work orders and the gas user features of the historical work orders). The smart gas management platform may calculate the vector distance between the clustering center of the corresponding cluster of a scheduling sub-domain and each vector of the above set of the historical order acceptance vectors, and determine the personnel that accept the work order corresponding to the historical order acceptance vector with the smallest vector distance as the personnel that accept the work order of the scheduling sub-domain. And so on, so that the personnel that accept the work orders of all scheduling sub-domains may be determined.

The method of some embodiments of the present disclosure improves the efficiency of accepting the work order and the efficiency of processing the work order by comprehensively analyzing the plurality of features of the work orders and constructing the plurality of scheduling sub-domains, thereby ensuring the efficient and orderly operation of the gas platform when the gas platform has a large count of different work orders, and.

FIG. 4 is an exemplary schematic diagram of determining a target scheduling sub-domain through a vector according to some embodiments of the present disclosure.

As shown in FIG. 4, the smart gas management platform may determine the work orders to be assigned based on a gas inquiry feature 411 and a gas user feature 412 of the work orders to be assigned; and determine a target scheduling sub-domain 440 corresponding to the work orders to be assigned based on sub-domain feature vectors 430 of a plurality of scheduling sub-domains and vectors of the work orders to be assigned 420.

In some embodiments, the work order to be assigned vector may be obtained by direct stitching based on gas inquiry feature and a gas user feature. For example, the vector of the work orders to be assigned may be denoted as (α.β), where α may denote the gas inquiry feature and β may denote the gas user feature. In some embodiments, the vector of the work orders to be assigned may be obtained by an embedding model based on the gas inquiry features and the gas user feature. In some embodiments, the gas inquiry feature and the gas user feature may be input to some trained embedding model, and an embedding vector output by the embedding model may be determined as the vector of the work orders to be assigned.

In some embodiments, the sub-domain feature vector may be determined based on the clustering feature of the clustering center of the cluster. Each cluster respectively has a cluster center, and the cluster centers have the corresponding clustering feature. More descriptions regarding the cluster and the clustering feature may be found in FIG. 3 and its related descriptions.

In some embodiments, when the vector of the work vectors to be assigned is determined by direct splicing, the sub-domain feature vector of the scheduling sub-domain may be obtained by direct splicing from the clustering feature corresponding to the clustering center of the cluster where it is located.

In some embodiments, when determining the vector of the work orders to be assigned by the embedding model, the sub-domain feature vector of the scheduling sub-domain may be the embedding vector obtained after inputting the clustering feature corresponding to the clustering center of the cluster where it is located to a trained embedding model.

In some embodiments, the sub-domain feature vector may be determined based on the clustering features of all work orders to be assigned currently included in the corresponding cluster.

For example, after clustering, 3 clusters o, p, and q are obtained. The 3 clusters may correspond to 3 scheduling sub-domains O, P, and Q respectively. Taking the sub-domain feature vector of scheduling sub-domain O as an example, when the vector of the work orders to be assigned is determined by direct splicing, the smart gas management platform may obtain the sub-domain feature vector of scheduling sub-domain O by taking am average value of the clustering feature of a same type of the plurality of gas work orders currently included in cluster o, and then splicing the clustering feature of each type after taking the average value of each type of the clustering feature.

As another example, when the amount of work vectors to be assigned is determined through the embedding model, the smart gas management platform may input the clustering feature of each type after taking the average value of each type of clustering feature to the trained embedding model. The embedding vector output from the embedding model may be used as the sub-domain feature vector of the scheduling sub-domain O.

The methods of some embodiments of the present disclosure determine a corresponding sub-domain feature vector through the clustering features of various current work orders to be assigned in the cluster, so that the sub-domain feature vector may reflect the features of various work orders to be assigned more comprehensively.

In some embodiments, the smart gas management platform may determine a similarity of the vector of the work orders to be assigned and the sub-domain feature vectors of various scheduling sub-domains by respectively performing a vector matching on the vector of the work orders to be assigned and the sub-domain feature vectors of various scheduling sub-domains. The similarity may be determined based on the vector distance (e.g., Euclidean distance, cosine distance, etc.) between the vectors of the work orders to be assigned and the sub-domain feature vectors. Understandably, the smaller the vector distance, the greater the similarity between the vectors. The smart gas management platform can determine the target scheduling sub-domains based on the similarity. For example, the smart gas management platform may determine the scheduling sub-domain corresponding to the sub-domain feature vector with the greatest similarity as the target scheduling sub-domain.

In some embodiments, the smart gas management platform may determine the similarity between the vector of the work orders to be assigned and each sub-domain feature vector; determine sub-domain busyness of each scheduling sub-domain; and determine the target scheduling sub-domain based on the similarity and the sub-domain busyness.

More instructions of how to determine the similarity may be found in the above descriptions.

The sub-domain busyness may be used to measure how busy the current scheduling sub-domain is.

In some embodiments, the smart gas management platform may determine the sub-domain busyness based on the count of work orders to be assigned and the count of personnel accepting the orders in the scheduling sub-domain. For example, sub-domain busyness=count of work orders to be assigned/count of personnel that accept the work order.

In some embodiments, the sub-domain busyness may be related to the urgency degree of the work orders to be assigned in the scheduling sub-domain and the order acceptance generic value of the personnel that accept the work orders in an entire scheduling sub-domain. More descriptions regarding the urgency degree and order acceptance generic values may be found in FIG. 5 and its associated descriptions.

In some embodiments, the sub-domain busyness of a scheduling sub-domain may be positively correlated to (E urgency degree of the work orders to be assigned)/(E order acceptance generic value of the personnel that accept the work order). A E urgency degree of the work orders to be assigned represents the sum of the urgency degree of all work orders to be assigned in that scheduling sub-domain. E order acceptance generic value of the personnel that accept the work order represents the sum of the generic values of all the personnel that accept the work order in the scheduling sub-domain. The larger the (E urgency degree of work orders to be assigned)/(E order acceptance generic value of the personnel that accept the work order) in the scheduling sub-domain, the busier the sub-domain is in that scheduling sub-domain.

The methods of some embodiment of the present disclosure determine the corresponding sub-domain feature vector through the clustering features of various current work orders to be assigned in the cluster, so that the sub-domain feature vector may reflect the features of various work orders to be assigned more comprehensively.

In some embodiments, among the sub-domain feature vectors corresponding to the scheduling sub-domains whose sub-domain busyness satisfies a preset condition (e.g., the sub-domain busyness is less than a preset threshold), the smart gas management platform may determine the sub-domain feature vectors with the greatest similarity to the work orders to be assigned, and determine the scheduling sub-domain corresponding to the sub-domain feature vector with the greatest similarity as the target scheduling sub-domain.

The methods of some embodiment of the present disclosure determine the appropriate target scheduling sub-region by determining the sub-domain busyness to avoid assigning the work orders to be assigned to a busier scheduling sub-domain, which causes a long waiting time for the work orders to be assigned, thereby improving a processing efficiency of subsequent work orders to be assigned.

The methods of some embodiment of the present disclosure obtain the work orders to be assigned and the target scheduling sub-domain by quantifying the work orders to be assigned and the sub-domain feature vector, so that the target scheduling sub-domain corresponding to the work orders to be assigned may be determined more accurately.

FIG. 5 is an exemplary flowchart illustrating a process of performing an order acceptance scheduling on work orders to be assigned according to some embodiments of the present disclosure.

Step 510, determining an urgency degree of the work orders to be assigned in a current scheduling sub-domain based on the inquiry type, a terminal feature, and a usage feature of the work orders to be assigned.

The urgency degree may be used to assess how urgent the work orders to be assigned needs to be processed.

In some embodiments, the smart gas management platform may preset a correspondence between different inquiry types, terminal features, usage features and different urgency degrees. For example, an inquiry type is that an urgency degree of the fault reporting may be highest, followed by other inquiry types (e.g., service complaints, gas device function inquiry, gas new product inquiry), etc. For example, in the terminal features, a larger terminal (e.g., a large boiler) may have a higher urgency degree than a smaller terminal (e.g., a gas stove). For example, in the usage features the more frequently gas is used and the longer the average time of using gas, the higher the degree of the urgency degree should be. Accordingly, the smart gas management platform may determine the urgency degree corresponding to the inquiry types, the terminal features, and the usage features of the current work orders to be assigned based on the inquiry types, the terminal features, and the usage features of the current work orders to be assigned and the corresponding.

In some embodiments, in response to the type of inquiry being the fault reporting, the urgency degree is related to the historical gas fault distribution and the fault location accuracy. More descriptions regarding the historical gas fault and difficulty of predicting the fault may be found in FIG. 3 and its associated descriptions.

In some embodiments, the more severe the fault type in the historical gas fault distribution, the more frequently the fault occurs, and the higher the urgency degree of the work orders to be assigned. Severity of the fault type may be determined based on historical experience data, manual determination, etc.

In some embodiments, the lower the difficulty of predicting the fault, the higher the urgency degree of the work orders to be assigned. The lower the difficulty of predicting the fault, the easier the fault type may be determined and the shorter the processing time of the work orders to be assigned. Therefore, prioritizing the work orders to be assigned may improve the efficiency of processing the work order.

The method of some embodiments of the present disclosure determines the urgency degree of the work orders to be assigned through the historical gas fault distribution of the fault and the accuracy of the fault location, thereby facilitating the work orders to be assigned with a higher urgency degree may be subsequently prioritized to process, ensuring the safe operation of the gas pipeline network.

Step 520, determining an order acceptance generic value of the personnel that accept the work orders in the current scheduling sub-domain based on the historical order acceptance distribution of the personnel that accept the work orders.

More descriptions of the personnel that accept the work orders may be found in FIG. 2 and its related descriptions.

The historical order distribution may reflect the history of personnel that accept the work orders to pick up work orders. Each personnel that accept the work order may have a corresponding historical order distribution. The historical order distribution may include a count of accepted orders, average completion time, average satisfaction degree, etc. of each type of the work order. The work orders of the same type may have the same features (e.g., a same gas inquiry feature and gas user feature, or a same gas inquiry feature, the gas user feature, and the gas work order feature). The average completion time may be determined based on the average of the completion times of the work orders of the same type. The average satisfaction degree may be determined based on the average of user satisfaction degree of the same type of work order.

In some embodiments, the historical order acceptance distribution may be exemplarily represented in the form of Table 1:

TABLE 1
Illustrative representation of historical order acceptance distribution

| | | Count of | Average | Average | |
|---|---|---|---|---|---|
| | | accepted | comple- | satisfaction | |
| | | orders | tion time | degree | . . . |
| 1 | Work order with a gas | xx | xx | xx | . . . |
| | inquiry feature a1, a gas | | | | |
| | user feature b1 (and gas | | | | |
| | work order feature c1) | | | | |
| 2 | Work order with a gas | xx | xx | xx | . . . |
| | inquiry feature a2, a gas | | | | |
| | user feature b2 (and a gas | | | | |
| | work order feature c2) | | | | |
| . . . | . . . | . . . | . . . | . . . | . . . |

The order acceptance generic value may be use to measure quality o the work order processed by the personnel that accept the work order. The higher the FULL value, the higher the quality of work order processed by the personnel that accept the work order.

In some embodiments, the difficulty of predicting the fault may be determined by the following equation (2):

$$U = \frac{var ( K )}{max ( K ) - min ( K )} \times {\sum }_{i} {k}_{i} \frac{{m}_{i}}{{n}_{i}} \qquad ( 2 )$$

where U is the order acceptance generic value. K is a set of the count of times of accepting the work orders with different features in the historical order acceptance distribution (i.e., K may include a plurality of times of accepting the work orders). var(K) is a variance of the count of times of accepting the work orders for different types of work orders. max (K) is a maximum count of times of accepting the work orders in the set of times of accepting the work orders. min(K) is a minimum count of times of accepting the work orders in the set of times of accepting the work orders. i may denote a row count in Table 1, i≥1. kᵢ is a count of times of accepting the work orders of the work orders in row i of Table 1. mᵢ is an average completion satisfaction degree of the work orders in row i of Table 1. nᵢ is an average completion time of the work orders in row i of Table 1.

It should be understood that the more balanced the personnel that accept the work order is of each type of work order, the shorter the average work order completion time, and the higher the average work order completion satisfaction degree, the greater the order acceptance generic value of the personnel that accept the work order.

Step 530, performing an order acceptance scheduling on the work orders to be assigned in the scheduling sub-domain based on the urgency degree of the work orders to be assigned and the order acceptance generic value of the personnel that accept the work order.

In some embodiments, the smart gas management platform may prioritize the personnel that accept the work orders with a low order generic values to receive the most urgent work orders to be assigned within a corresponding available range for accepting the work order. It may be understood that by giving priority to personnel that accept the work orders with low order generic value, the personnel that accept the work orders in the scheduling sub-domain may be fully scheduled, avoiding a situation that the personnel that accept the work order has no order to take, and improving an order toleration rate of the scheduling sub-domain.

In some embodiments, each personnel that accept the work order has a preset range of available orders based on the historical experience data, a system default range. The available range for accepting the work order may include, for example, the user type. For example, the available range for accepting the work order may include the gas fault occurring in a residential user, the gas fault occurring in a commercial user, the gas fault occurring in an industrial user, etc.

In some embodiments, the smart gas management platform may also prioritize the personnel that accept the work order with a high order generic value to accept the work order with the highest current urgency degree among all work orders to be assigned in the current scheduling sub-domain.

The method of some embodiments of the present disclosure improves the efficiency of accepting the work order and the efficiency of processing the work order by comprehensively analyzing the plurality of features of the work orders and constructing the plurality of scheduling sub-domains, thereby ensuring the efficient and orderly operation of the gas platform when the gas platform has the large count of different work orders.

The embodiments of the present disclosure also provide a non-transitory computer-readable storage medium, the storage medium may store computer instructions, and when the computer reads the computer instructions in the storage medium, the computer executes any one of the above method for optimizing smart gas work order scheduling provided in the embodiments of the present disclosure.

The basic concepts have been described above, apparently, for those skilled in the art, the above-detailed disclosure is only an example, and does not constitute a limitation of the specification. Although it is not clearly stated here, technical personnel in the art may modify, improve, and amend the present disclosure. The amendments, improvements, and amendments are recommended in the present disclosure, so the amendments, improvements, and amendments still belong to the spirit and scope of the demonstration embodiments of the present disclosure.

At the same time, the present disclosure uses a specific word to describe the embodiments of the present disclosure. For example, “one embodiment”, “an embodiment”, and/or “some embodiments” means a feature, structure, or feature of at least one embodiment related to the present disclosure. Therefore, it should be emphasized and noted that in the present disclosure, “one embodiment” or “an embodiment” or “an alternative embodiment” that are mentioned in different positions in the present disclosure do not necessarily mean the same embodiment. In addition, some features, structures, or features of one or more embodiments in the present disclosure may be properly combined.

In addition, unless the claims are clearly stated, the order of the processing elements and sequences, the use of digital letters, or the use of other names described in this description are not used to limit the order and method of the present disclosure process and method. Although in the above disclosure, some examples are discussed through various examples that are currently considered useful, it should be understood that these types of details are only explained. The additional claims are not limited to the implementation examples of the disclosure. The requirements are required to cover all the amendments and equivalent combinations that meet the essence and scope of the implementation of the present disclosure. For example, although the implementation of various components described above may be embodied in a hardware device, it may also be implemented as a software-only solution, e.g., an installation on an existing server or mobile device.

In the same way, it should be noted that, to simplify the statement of the disclosure and help the understanding of one or more embodiments, in the descriptions of the embodiments of the present disclosure, sometimes multiple features will be attributed to one embodiment, figures, or its descriptions. However, this disclosure method does not mean that the feature required by the object of this description is more than the feature mentioned in the claims. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Therefore, by way of example, but not of limitation, alternative configurations of the embodiments of the application may be utilized in accordance with the teachings herein. Accordingly, embodiments of the present application are not limited to that precisely as shown and described.

What is claimed is:

1. A method for optimizing smart gas work order scheduling implemented by an Internet of Things system for optimizing smart gas work order scheduling, the Internet of Things system comprising a smart gas user platform, a smart gas service platform, and a smart gas management platform that interact in sequence, and the method being executed by the smart gas management platform, comprising:
obtaining a newly-generated work order to be assigned from the smart gas service platform, wherein the newly-generated work order to be assigned is generated by the smart gas service platform based on a gas processing request received from the smart gas user platform;
determining at least one target scheduling sub-domain corresponding to the work order to be assigned from a plurality of scheduling sub-domains based on a gas inquiry feature of the work order to be assigned and a gas user feature of the work order to be assigned through a preset approach, wherein the gas inquiry feature includes at least one of an inquiry type and inquiry location information, and the gas user feature includes at least one of a user type, a terminal type, and a usage feature; and
assigning the work order to be assigned to a corresponding target scheduling sub-domain.

2. The method for optimizing smart gas work order scheduling of claim 1, wherein
the plurality of scheduling sub-domains are determined based on historical work order to be assigned within a preset time period, wherein the operation of determining the plurality of scheduling sub-domains based on a historical work order to be assigned within a preset time period includes:
determining a preset count of clustering centers;
determining a preset count of clusters by clustering the historical work order to be assigned within the preset time period, wherein a clustering feature for clustering at least includes the gas inquiry feature and the gas user feature; and
determining each cluster of the preset count of the clusters as a scheduling sub-domain.

3. The method for optimizing smart gas work order scheduling of claim 2, wherein the clustering feature further includes a gas work order feature, and the gas work order feature includes at least one of a call inquiry duration and a message interaction degree.

4. The method for optimizing smart gas work order scheduling of claim 2, wherein the clustering feature further includes a historical gas fault distribution and fault inquiry data.

5. The method for optimizing smart gas work order scheduling of claim 2, wherein the determining the at least one target scheduling sub-domain corresponding to the work order to be assigned from the plurality of scheduling sub-domains based on the gas inquiry feature and the gas user feature of the work order to be assigned through a preset approach, including:
determining a vector of the work order to be assigned based on the gas inquiry feature of the work order to be assigned and the gas user feature of the work order to be assigned; and
determining the target scheduling sub-domain corresponding to the work order to be assigned based on the vector of the work order to be assigned and sub-domain feature vectors of the plurality of scheduling sub-domains, wherein the sub-domain feature vectors are determined based on the clustering features of the clustering centers of the clusters.

6. The method for optimizing smart gas work order scheduling of claim 5, wherein the determining the target scheduling sub-domain corresponding to the work order to be assigned based on the vector of the work order to be assigned and the sub-domain feature vectors of the plurality of scheduling sub-domains includes:
determining similarity of the vector of the work order to be assigned and each sub-domain feature vector;
determining sub-domain busyness of each scheduling sub-domain; and
determining the target scheduling sub-domain based on the similarity and the sub-domain busyness.

7. The method for optimizing smart gas work order scheduling of claim 1, further comprising:
performing an order acceptance scheduling on the work order to be assigned in each scheduling sub-domain.

8. The method for optimizing smart gas work order scheduling of claim 7, wherein the performing the order acceptance scheduling on the work orders to be assigned in each scheduling sub-domain includes:
determining an urgency degree of the work order to be assigned in a current scheduling sub-domain based on the inquiry type, a terminal feature and a usage feature of the work order to be assigned;
determining an order acceptance generic value of personnel that accept a work order in the current scheduling sub-domain based on a historical order acceptance distribution of the personnel that accept the work order; and
performing the order acceptance scheduling on the work order to be assigned in the scheduling sub-domain based on the urgency degree of the work order to be assigned and the order acceptance generic value of the personnel that accept the work order.

9. The method for optimizing smart gas work order scheduling of claim 8, further including:
in response to the inquiry type being a fault report, determining the urgency degree based on a historical gas fault distribution and a fault location accuracy.

10. The method for optimizing smart gas work order scheduling of claim 1, wherein
the Internet of Things system also includes a smart gas sensor network platform and a smart gas object platform;
the smart gas management platform includes a smart management sub-platform and a smart gas data center;
the method is executed by the smart management sub-platform, and further includes:
obtaining the work order to be assigned from the smart gas service platform based on the smart gas data center.

11. An Internet of Things system for optimizing smart gas work order scheduling, wherein the Internet of Things system comprises a smart gas user platform, a smart gas service platform, and a smart gas management platform that interact in sequence, and the smart gas management platform is configured to:
obtain a newly-generated work order to be assigned from the smart gas service platform, wherein the newly-generated work order to be assigned is generated by the smart gas service platform based on a gas processing request received from the smart gas user platform;
determine at least one target scheduling sub-domain corresponding to the work order to be assigned from a plurality of scheduling sub-domains based on a gas inquiry feature of the work order to be assigned and a gas user feature of the work order to be assigned through a preset approach, wherein the gas inquiry feature includes at least one of an inquiry type and inquiry location information, and the gas user feature includes at least one of a user type, a terminal type, and a usage feature; and
assign the work order to be assigned to a corresponding target scheduling sub-domain.

12. The Internet of Things system for optimizing smart gas work order scheduling of claim 11, wherein the smart gas management platform is further configured to:
determine the plurality of scheduling sub-domains based on a historical work order to be assigned within a preset time period, including:
determining a preset count of clustering centers;
determining a preset count of clusters by clustering the historical work order to be assigned within the preset time period, wherein a clustering feature for clustering at least includes the gas inquiry feature and gas user feature; and
determining each cluster of the preset count of the clusters as a scheduling sub-domain.

13. The Internet of Things system for optimizing smart gas work order scheduling of claim 12, wherein the clustering feature further includes a gas work order feature, and the gas work order feature includes at least one of a call inquiry duration and a message interaction degree.

14. The Internet of Things system for optimizing smart gas work order scheduling of claim 12, wherein the clustering feature further includes a historical gas fault distribution and fault inquiry data.

15. The Internet of Things system for optimizing smart gas work order scheduling of claim 12, wherein the smart gas management platform is further configured to:
determine a vector of the work order to be assigned based on the gas inquiry feature of the work order to be assigned and the gas user feature of the work order to be assigned; and
determine a target scheduling sub-domain corresponding to the work order to be assigned based on the vector of the work order to be assigned and sub-domain feature vectors of the plurality of scheduling sub-domains, wherein the sub-domain feature vectors are determined based on the clustering features of the clustering centers of the cluster.

16. The Internet of Things system for optimizing smart gas work order scheduling of claim 15, wherein the smart gas management platform is further configured to:
determining similarity of the vector of the work order to be assigned and each sub-domain feature vector;
determining sub-domain busyness of each scheduling sub-domain; and
determining the target scheduling sub-domain based on the similarity and the sub-domain busyness.

17. The Internet of Things system for optimizing smart gas work order scheduling of claim 11, wherein the smart gas management platform is further configured to:
performing an order acceptance scheduling the work order to be assigned in scheduling sub-domain.

18. The Internet of Things system for optimizing smart gas work order scheduling of claim 17, wherein the smart gas management platform is further configured to
determine urgency degree of the work order to be assigned in a current scheduling sub-domain based on the inquiry type, a terminal feature and a usage feature of the work order to be assigned;
determine an order acceptance generic value of personnel that accept a work order in the current scheduling sub-domain based on a historical order acceptance distribution of the personnel that accept the work order; and
perform the order acceptance scheduling on the work order to be assigned in the scheduling sub-domain based on the urgency degree of the work order to be assigned and the order acceptance generic value of the personnel that accept the work order.

19. The Internet of Things system for optimizing smart gas work order scheduling of claim 18, wherein the smart gas management platform is further configured to:
in response to the inquiry type being a fault reporting, determining the urgency degree based on a historical gas fault distribution and a fault location accuracy.

20. A non-transitory computer-readable storage medium storing computer instructions, wherein when reading the computer instructions in the storage medium, a computer executes a method for optimizing smart gas work order scheduling of claim 1.
